(19) United States
(12) Patent Application Publication
(10) Pub. No.: US 2026/0288087 A1
(43) Pub. Date: Sep. 24, 2026

(54) SYSTEM AND METHOD FOR PROCESSING OPTIMIZATION THROUGH SIMILARITY ANALYSIS

(71) Applicant: NAN YA PLASTICS CORPORATION, Taipei City (TW)

(72) Inventors: Ching-Yao Yuan, Taipei City (TW); Cheng-Li Chao, Taipei City (TW); Yu Ti Tseng, Taipei City (TW)

(73) Assignee: NAN YA PLASTICS CORPORATION, Taipei City (TW)

(21) Appl. No.: 19/200,719

(22) Filed: May 7, 2025

(30) Foreign Application Priority Data
Mar. 20, 2025 (TW) 114110492

(51) Int. Cl. G05B 13/02

(52) U.S. Cl. CPC G05B 13/024

(57) ABSTRACT

This disclosure provides a system and a method for process optimization through similarity analysis, selecting at least one historical process data closest to the target process from historical data, adjusting parameters based on the historical process data to obtain the target process, and then verifying the accuracy of the target process to ensure the quality of products produced using the target process. Not only may the above reduce cost of testing and production risks, but also systematically adjust the weight of parameters to produce a suitable process for subsequent production, thereby shortening development time and improving yield.

### CROSS-REFERENCE TO RELATED APPLICATION

This application claims the priority benefit of Taiwan application serial no. 114110492, filed on Mar. 20, 2025. The entirety of the above-mentioned patent application is hereby incorporated by reference herein and made a part of this specification.

### BACKGROUND OF THE INVENTION

### Field of the Invention

The invention relates to a process optimization system and method, and more particularly to a system and a method for processing optimization through similarity analysis.

### Description of Related Art

Whenever a new product needs to be produced using new specifications, the production conditions often rely on the experience of engineers or on establishing the process through experiments. However, adjusting parameters through trial and error may readily lead to waste of raw materials, extended development time, and increased development costs. Even if engineers rely on past experience to set initial parameters, they may still be unable to adjust parameters since the key parameters of the new product are different from past specifications, resulting in poor initial yield and substandard product performance. Furthermore, it is difficult to cope with high-precision and high-variability processes by adjusting process parameters based on past experience. Therefore, how to systematically develop new processes for new products is an important issue.

### SUMMARY OF THE INVENTION

Accordingly, the disclosure provides a system and a method for processing optimization through similarity analysis that establish an optimized target process by comparing the similarity between parameters of past process data and parameters of a target process.

The disclosure provides a system for processing optimization through similarity analysis, including a storage and a processor. The storage stores a plurality of modules. The processor is coupled to the storage and configured to: obtain a plurality of data corresponding to a plurality of specifications; execute a pre-processing module in the plurality of modules to adjust a plurality of weights corresponding to a plurality of factors in the plurality of specifications; execute an encoding module in the plurality of modules to encode the plurality of factors; execute a comparison module in the plurality of modules to calculate a plurality of similarities according to a target process and the plurality of encoded factors; execute an analysis module in the plurality of modules to obtain target data according to the plurality of similarities, and calculate a plurality of target process factors corresponding to the target process according to the target data; and establish an optimized target process according to the plurality of target process factors.

The disclosure further provides a method for processing optimization through similarity analysis, including: obtaining a plurality of data corresponding to a plurality of specifications; adjusting a plurality of weights corresponding to a plurality of factors in the plurality of specifications; encoding the plurality of factors; calculating a plurality of similarities according to a target process and the plurality of encoded factors; obtaining target data according to the plurality of similarities, and calculating a plurality of target process factors corresponding to the target process according to the target data; and establishing an optimized target process according to the plurality of target process factors.

Based on the above, this disclosure provides a system and a method for process optimization through similarity analysis, selecting at least one historical process data closest to the target process from historical data, adjusting parameters based on the historical process data to obtain the target process, and then verifying the accuracy of the target process to ensure the quality of products produced using the target process. Not only may the above reduce cost of testing and production risks, but also systematically adjust the weight of parameters to produce a suitable process for subsequent production, thereby shortening development time and improving yield.

### BRIEF DESCRIPTION OF THE DRAWINGS

FIG. 1 is a schematic diagram of a system for processing optimization through similarity analysis of the disclosure.

FIG. 2 is a flowchart of executing a system for processing optimization through similarity analysis of the disclosure.

FIG. 3 is a detailed flowchart of executing a system for processing optimization through similarity analysis of the disclosure.

### DESCRIPTION OF THE EMBODIMENTS

Reference will now be made in detail to exemplary embodiments of the disclosure, examples of which are illustrated in the accompanying drawings. The terms “first”, “second”, etc. mentioned in the entire specification of the present application (including the claims) are used to name the elements or distinguish different embodiments or scopes, and are not used to limit the upper or lower limit of the number of elements, nor to limit the order of the elements. In addition, wherever possible, elements/members using the same reference numerals in the drawings and embodiments denote the same or similar parts.

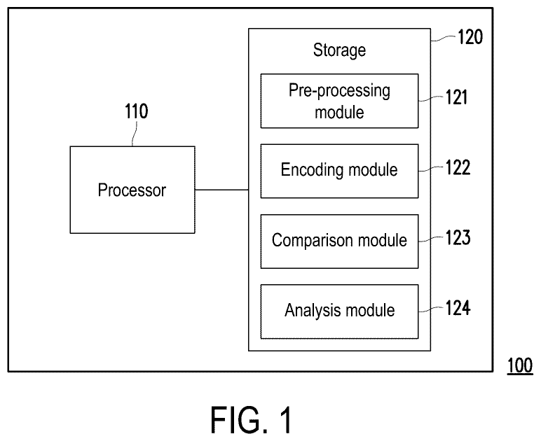

FIG. 1 is a schematic diagram of a system for processing optimization through similarity analysis of the disclosure. A system 100 for processing optimization through similarity analysis may include a processor 110 and a storage 120.

In an embodiment of the disclosure, the processor 110 is, for example, a central processing unit (CPU), or other programmable general-purpose or special-purpose micro control unit (MCU), microprocessor, digital signal processor (DSP), programmable controller, application-specific integrated circuit (ASIC), graphics processing unit (GPU), image signal processor (ISP), image processing unit (IPU), arithmetic logic unit (ALU), complex programmable logic device (CPLD), field-programmable gate array (FPGA), or other similar elements, or a combination of the above elements. In the system 100 for processing optimization through similarity analysis, the processor 110 may be coupled to the storage 120, and the processor 110 may execute each module stored in the storage 120.

The storage 120 is, for example, any type of fixed or removable random-access memory (RAM), read-only memory (ROM), flash memory, hard-disk drive (HDD), solid-state drive (SSD), or similar elements, or a combination of the above elements, and is used to store a plurality of models or various applications that may be executed by the processor 110. In the present embodiment, the storage 120 may store at least a pre-processing module 121, an encoding module 122, a comparison module 123, and an analysis module 124.

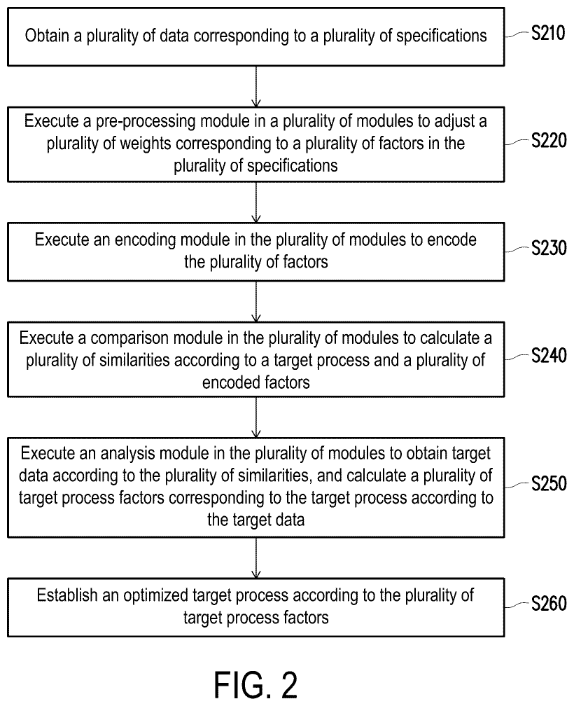

Please refer to FIG. 2. FIG. 2 is a flowchart of a system for processing optimization through similarity analysis of the disclosure. In process S210, the processor 110 may obtain a plurality of data corresponding to a plurality of specifications. In process S220, the processor 110 may execute a pre-processing module in the plurality of modules to adjust a plurality of weights corresponding to a plurality of factors in the plurality of specifications. In process S230, the processor 110 may execute an encoding module in the plurality of modules to encode the plurality of factors. In process S240, the processor 110 may execute a comparison module in the plurality of modules to calculate a plurality of similarities according to a target process and a plurality of encoded factors. In process S250, the processor 110 may execute an analysis module in the plurality of modules to obtain target data according to the plurality of similarities, and calculate a plurality of target process factors corresponding to the target process according to the target data. In process S260, the processor 110 may establish an optimized target process according to the plurality of target process factors.

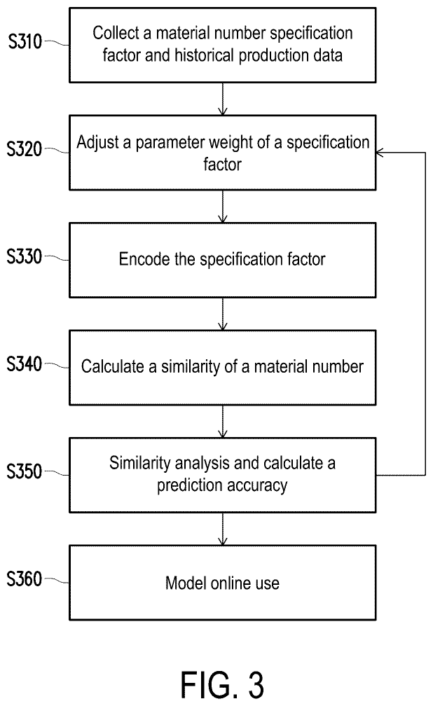

Please refer to FIG. 3. FIG. 3 is a detailed flowchart of executing the system for processing optimization through similarity analysis of the disclosure. In process S310, the processor 110 may collect a material number specification factor and historical production data. Specifically, the processor 110 may disassemble the target process corresponding to the target product to obtain a plurality of target process factors, the processor 110 may obtain historical process data including at least one target process factor in the past process according to the plurality of target process factors, and the processor 110 may obtain historical production data corresponding to the historical process data. The processor 110 may be further optimized according to the resulting process data, and the processor 110 may use the historical production data to verify the accuracy of a subsequent process.

Furthermore, the historical process data includes at least one specification. That is, for example, a first material and a second material may be used to manufacture a printed circuit board, wherein the ratio of the first material to the second material may be 2:3 and 3:2. When the target process factor includes the first material and the second material, the first historical process data and the second historical process data corresponding to the specifications of the first material and the second material having a ratio of 2:3 and 3:2 respectively may both be selected as data for target process optimization. In addition, the first historical production data and the second historical production data using the first historical process data and the second historical process data may also be obtained. The first historical production data and the second historical production data may be used at least as a subsequent accuracy prediction.

Please continue to refer to FIG. 3, in process S320, the processor 110 may adjust the parameter weight of the specification factor. Specifically, the processor 110 may adjust the collected historical process data accordingly according to the usage scenario of the target process. For example, the target process needs to be performed in an environment at 40 degrees Celsius or less, and the historical process data is performed at a temperature of 60 degrees Celsius or above. Since different temperatures may cause the phase state of the material to change, the processor 110 may adjust the weight corresponding to the material factor in the historical process data according to the usage scenario of the target process or the time point of the historical process data used. The above factors may include size, material, and structure.

Continuing from the above, the size may include the length and the width of the product, the material may include type of material, material composition, and material surface treatment method, and the structure may include the thickness and the number of layers of the product. All the molds, materials that may be used in the production process, and the relevant specifications of the finished product are all part of the above factors.

Continuing to refer to FIG. 3, in process S330, the processor 110 may encode the specification factor. For example, the processor 110 may encode the above factors using label encoding, one-hot encoding, or mean encoding.

Please continue to refer to FIG. 3. In process S340, the processor 110 may calculate the similarity of the material numbers. Specifically, there may be differences in factors such as molds and materials used between the target process and the historical process. The processor 110 may use Euclidean distance to calculate similarity for factors belonging to numerical variables. For example, the processor 110 may use Euclidean distance to calculate length similarity, width similarity, and thickness similarity for length, width, and thickness in the factors. The processor 110 may also use Jaccard similarity or cosine similarity to calculate similarity for factors belonging to categorical variables. For example, the processor 110 may use Jaccard similarity or cosine similarity to calculate material type similarity and material composition similarity for the material type and the material composition in the factors. The above method for calculating the similarity between the target process and the historical process is only an example, and any method for calculating similarity known to those skilled in the art of data analysis may be used in the disclosure to calculate the similarity between the target process and the historical process.

Please continue to refer to FIG. 3, in process S350, the processor 110 may analyze the similarity and calculate the prediction accuracy. Specifically, the processor 110 can, for example, calculate the overall similarity from length similarity, width similarity, thickness similarity, material type similarity, and material composition similarity obtained above, and the processor 110 may calculate different overall similarities between different historical process data and the target process respectively, and then the processor 110 establishes the target data from the historical process data corresponding to the maximum overall similarity in the different overall similarities. The processor 110 may calculate the overall similarity by, for example, averaging the similarities of all factors to obtain the overall similarity, or the processor 110 may first adjust the similarities of all factors according to weights and then average the above to obtain the overall similarity.

Continuing from the above, the processor 110 may also set a similarity threshold and obtain a plurality of historical process data corresponding to all factors greater than the similarity threshold from different overall similarities. The processor 110 may perform a weighted average of the similarities corresponding to each factor in each historical process data to establish the target data.

Further continuing from the above, the target data established by the processor 110 is the material number production parameter of the new process. In process S350, the processor 110 may execute the prediction module to further calculate the prediction accuracy of the target data. That is, before the target data is officially put online for use, the processor 110 needs to first calculate whether the accuracy meets expectations if the target data is used to produce products. When the processor 110 calculates the material number similarity in process S340, the processor 110 may use the production data corresponding to some historical material numbers as verification of the accuracy of the established target data. The retained production data may account for 5% to 20% of all production data, for example.

Continuing from the above, the processor 110 may adjust the conditions for prediction accuracy according to the characteristics of the product produced by the target data. For example, when the prediction target is the thickness of the product, the processor 110 may compare the target product thickness produced using the target data and the historical product thickness produced using the historical process data. The processor 110 may determine that the prediction is correct when the difference between the characteristics of the product produced using the target data and the characteristics of the product produced using the historical process data is less than a characteristic threshold. For example, if the difference between the target product thickness and the historical product thickness is less than or equal to 10% of the historical product thickness, the prediction is correct; if the difference between the target product thickness and the historical product thickness is greater than 10% of the historical product thickness, the prediction is incorrect. The processor 110 may use each of the retained production data to compare the target product thickness with the historical product thickness to obtain a prediction result (correct or incorrect) corresponding to each of the production data. Assuming that the retained production data is 100 records, and 85 predictions are correct and 15 predictions are incorrect, the accuracy is 85%.

Please continue to refer to FIG. 3. When the prediction accuracy is too low, that is, the prediction accuracy is less than a threshold value, the processor 110 may return to process S320 to adjust the parameter weight of the specification factor, and the processor 110 may adjust the weight of the factor according to the detailed usage scenario of the target process. For example, when the processor 110 originally only uses the temperature of the target process as the basis for adjusting the factor weight, in the case where the prediction accuracy is too low, the processor 110 may use the temperature and the pressure of the target process as the basis for adjusting the factor weight. The accuracy may be too low, for example, less than 80%.

Please continue to refer to FIG. 3. When the prediction accuracy meets expectations, the processor 110 may execute process S360 and put the model online. That is, if the product produced using the target process is not much different from the product produced using the historical process, the processor 110 may package the target process into a process model to be provided for production use.

The following is a specific example to illustrate each process of FIG. 3. Please refer to Table 1 below. Table 1 shows that the processor 110 uses the same batch of historical process data but uses different factor encoding methods and different similarity calculation methods to establish a target process.

TABLE 1

| | Case | |
|---|---|---|
| Process | Case 1 | Case 2 |
| S310 | Historical process data | |
| S320 | Factor and weight adjustment | |
| S330 | Label encoding | Non-label encoding |
| S340 | Euclidean distance | Non-Euclidean distance |
| S350 | Arithmetic average of 20 | Arithmetic average of 20 |
| | batches, 3 most similar | batches, 5 most similar |
| | material numbers | material numbers |
| Prediction accuracy | 82 | 87 |
| (%) | | |

As shown in Table 1, since the target processes of Case 1 and Case 2 are the same process, the processor 110 may use the same historical process data in process S310 in Case 1 and Case 2, and the processor 110 may adjust the weight for the same factor in process S320. In process S330 of Case 1, the processor 110 may use label encoding to encode factors, and in process S340, the processor 110 may use Euclidean distance to calculate the similarity between the target process and the historical process. In process S350, the processor 110 takes the average of the three material numbers with the greatest similarity as the predicted value, and each material number is calculated as the arithmetic mean of 20 batches of production. Lastly, the processor 110 obtains a prediction accuracy of 82%. However, in Case 2, the processor 110 adopts a different encoding method and a different similarity calculation method in process S330 and process S340 from those in Case 1, and in process S350, the processor 110 takes the average of the five material numbers with the greatest similarity as the prediction value, and lastly the processor 110 obtains a prediction accuracy of 87%.

It may be seen from the above embodiments that the processor 110 may achieve the final different prediction accuracies by encoding historical data and calculating distances.

The above embodiments may be applied to the establishment of various processes. For example, the above embodiments may be applied to at least semiconductor manufacturing, chemical material synthesis, precision machining, plastic molding, metal processing and electronic manufacturing to improve development efficiency and production yield of new products.

The disclosure further provides a method for processing optimization through similarity analysis, and the method may be executed by the processor 110. The detailed processes in the method are all recited in the above paragraphs and are not repeated here.

Based on the above, this disclosure provides a system and a method for process optimization through similarity analysis, selecting at least one historical process data closest to the target process from historical data, adjusting parameters based on the historical process data to obtain the target process, and then verifying the accuracy of the target process to ensure the quality of products produced using the target process. Not only may the above reduce cost of testing and production risks, but also systematically adjust the weight of parameters to produce a suitable process for subsequent production, thereby shortening development time and improving yield.

What is claimed is:

1. A system for processing optimization through similarity analysis, comprising:
a storage storing a plurality of modules; and
a processor coupled to the storage and configured to:
obtain a plurality of data corresponding to a plurality of specifications;
execute a pre-processing module in the modules to adjust a plurality of weights corresponding to a plurality of factors in the specifications;
execute an encoding module in the modules to encode the factors;
execute a comparison module in the modules to calculate a plurality of similarities according to a target process and the encoded factors;
execute an analysis module in the modules to obtain target data according to the similarities, and calculate a plurality of target process factors corresponding to the target process according to the target data; and
establish an optimized target process according to the target process factors.

2. The system for processing optimization through similarity analysis of claim 1, wherein the weights correspond to a usage scenario of the target process.

3. The system for processing optimization through similarity analysis of claim 1, wherein the factors comprise a size, a material, and a structure.

4. The system for processing optimization through similarity analysis of claim 1, wherein the processor is further configured to:
encode the factors using label encoding, one-hot encoding, or mean encoding.

5. The system for processing optimization through similarity analysis of claim 1, wherein the processor is further configured to:
calculate the plurality of similarities according to the plurality of target process factors of the target process and a plurality of data factors of each data in the data.

6. The system for processing optimization through similarity analysis of claim 5, wherein the processor is further configured to:
calculate a similarity for the factors belonging to numerical variables using a Euclidean distance; and
calculate the similarity for the factors belonging to categorical variables using a Jaccard similarity or a cosine similarity.

7. The system for processing optimization through similarity analysis of claim 6, wherein the processor is further configured to:
establish the target data according to first data in the data, wherein there is a first overall similarity between the first data and the target process, there is a second overall similarity between second data in the data and the target process, and the first overall similarity is greater than the second overall similarity.

8. The system for processing optimization through similarity analysis of claim 6, wherein the processor is further configured to:
establish the target data according to a plurality of third data in the data, wherein there is a third overall similarity between each of the third data and the target process, and the third overall similarity is greater than a first threshold.

9. The system for processing optimization through similarity analysis of claim 1, wherein the processor is further configured to:
execute a prediction module in the modules to predict an accuracy of the optimized target process.

10. The system for processing optimization through similarity analysis of claim 9, wherein the processor is further configured to:
adjust the weights according to a detailed usage scenario of the target process in response to the accuracy being less than a second threshold.

11. A method for processing optimization through similarity analysis, comprising:
obtaining a plurality of data corresponding to a plurality of specifications;
adjusting a plurality of weights corresponding to a plurality of factors in the specifications;
encoding the factors;
calculating a plurality of similarities according to a target process and the encoded factors;
obtaining target data according to the similarities, and calculating a plurality of target process factors corresponding to the target process according to the target data; and
establishing an optimized target process according to the target process factors.

12. The method for processing optimization through similarity analysis of claim 11, wherein the weights correspond to a usage scenario of the target process.

13. The method for processing optimization through similarity analysis of claim 11, wherein the factors comprise a size, a material, and a structure.

14. The method for processing optimization through similarity analysis of claim 11, further comprising:
encoding the factors using label encoding, one-hot encoding, or mean encoding.

15. The method for processing optimization through similarity analysis of claim 11, further comprising:
calculating the plurality of similarities according to the plurality of target process factors of the target process and a plurality of data factors of each data in the data.

16. The method for processing optimization through similarity analysis of claim 15, further comprising:
calculating a similarity for the factors belonging to numerical variables using a Euclidean distance; and
calculating the similarity for the factors belonging to categorical variables using a Jaccard similarity or a cosine similarity.

17. The method for processing optimization through similarity analysis of claim 16, further comprising:
establishing the target data according to first data in the data, wherein there is a first overall similarity between the first data and the target process, there is a second overall similarity between second data in the data and the target process, and the first overall similarity is greater than the second overall similarity.

18. The method for processing optimization through similarity analysis of claim 16, further comprising:
establishing the target data according to a plurality of third data in the data, wherein there is a third overall similarity between each of the third data and the target process, and the third overall similarity is greater than a first threshold.

19. The method for processing optimization through similarity analysis of claim 11, further comprising:
predicting an accuracy of the optimized target process.

20. The method for processing optimization through similarity analysis of claim 19, further comprising:
adjusting the weights according to a detailed usage scenario of the target process in response to the accuracy being less than a second threshold.
